(19) United States
(12) Patent Application Publication
(10) Pub. No.: US 2004/0065496 A1
(43) Pub. Date: Apr. 8, 2004

(54) Fascia-mounted shift lever bracket

(76) Inventor: Duck-Ki Kim, Gyeonggi-do (KR)

Correspondence Address: MORGAN, LEWIS & BOCKIUS, LLP., 3300 HILLVIEW AVENUE, PALO ALTO, CA, 94304, US

(21) Appl. No.: 10/443,901

(22) Filed: May 21, 2003

(30) Foreign Application Priority Data
Oct. 4, 2002 (KR) 2002-60632

(51) Int. Cl. B60R 21/00

(52) U.S. Cl. 180/271

(57) ABSTRACT

A fascia-mounted shift lever bracket absorbs impact and minimizes injury to the occupant(s) of a vehicle when the occupant(s) contact the fascia-mounted shift lever assembly in a vehicle collision or the like. Upon impact, the fastened state of the mounting bracket that supports the fascia-mounted shift lever is displaced and absorbs energy of the impact.

### FIELD OF THE INVENTION

Generally, the present invention relates to a fascia-mounted shift lever bracket for a vehicle. More particularly, the present invention relates to a bracket for supporting a fascia-mounted shift lever that minimizes injury to a driver or passenger during a collision.

### BACKGROUND OF THE INVENTION

Conventionally, a shift lever is installed on the floor-board, between two front seats, or mounted on a fascia of a vehicle. The shift lever mounted at the fascia facilitates movement between the two front seats and is advantageous in preventing passengers from making false gear change manipulations.

However, there are drawbacks to having the shift lever mounted on the fascia. One drawback is that the shift lever often becomes an obstacle that causes severe injury to the driver and/or passenger during an accident. Another drawback is that the structure of a conventional fascia-mounted shift lever bracket is not designed with an impact absorbing function.

### SUMMARY OF THE INVENTION

The present invention provides a fascia-mounted shift lever bracket that absorbs impact forces incurred when the occupant comes in contact with the fascia-mounted shift lever assembly during a traffic collision or accident.

In accordance with an embodiment of the present invention, a fascia-mounted shift lever bracket comprises a mounting frame having one side rotatively coupled at a lower frame. A support rod for connecting and supporting the lower frame and the other side of the mounting frame is also included. The support rod and the mounting frame are connected by a first fixing means that will be destroyed when more than a certain level of load is applied to the mounting frame. Also connecting the mounting frame and supporting rod is a second fixing means that becomes fixed following a certain degree of rotation of the mounting frame when the first fixing means is destroyed.

According to a preferred embodiment, the first fixing means may be a plurality of plastic pins that fix the mounting frame and support rod. The second fixing means includes a guide hole vertically formed in the support rod and a guide pin fixed in the mounting frame, inserted into the guide hole. Accordingly, the second fixing means may be constructed with a guide groove vertically formed in the support rod, a concave part formed in the guide groove, a ball inserted into the concave part, and an elastic spring installed in the mounting bracket that elastically supports the ball toward the concave part.

In accordance with another embodiment of the present invention, a fascia-mounted shift lever bracket comprises a mounting frame having a side rotatively coupled at a lower frame and a support rod connecting and supporting the lower frame to the other side of the mounting frame. A fixing means is installed at a connection part between the support rod and the mounting frame. The fixing means will be destroyed when more than a certain level of load is applied to the mounting frame. The fixing means may be constructed with a plurality of plastic pins.

### BRIEF DESCRIPTION OF THE DRAWINGS

For fuller understanding of the nature and objects of the invention, reference should be made to the following detailed description taken in conjunction with the accompanying drawings in which:

FIG. 1 illustrates the structure of a fascia-mounted shift lever bracket in accordance with an embodiment of the present invention;

FIG. 2 is a lateral view illustrating an initial mounting state of the bracket in FIG. 1;

FIG. 3 illustrates a state where the mounting frame of FIG. 1 is rotated;

FIG. 4 is a perspective view illustrating a connecting part between the support rod and the mounting frame of FIG. 1;

FIG. 5 is a cross-sectional view taken along line V-V of FIG. 4;

FIG. 6 illustrates a structure of a connecting part between the support rod and the mounting frame in accordance with another embodiment of the present invention; and

FIG. 7 is a cross-sectional view taken along line VII-VII of FIG. 6.

### DETAILED DESCRIPTION OF THE INVENTION

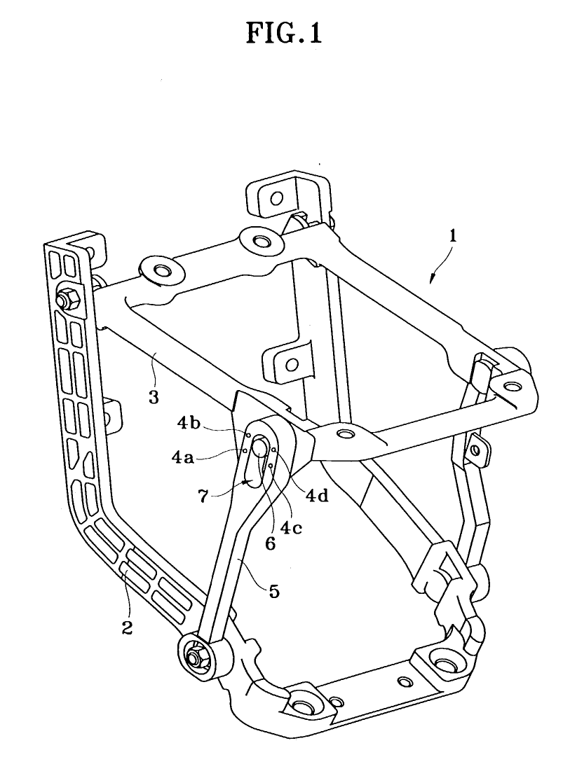

FIG. 1 illustrates a fascia-mounted shift lever bracket 1 in accordance with an embodiment of the present invention. The bracket 1 is generally constructed in an “L” shape with a lower frame 2 fixed to the body of a vehicle. A mounting frame 3 is positioned for receiving the mounting of a shift lever assembly and a support rod 5 connects and supports the lower frame 2 with the mounting frame 3.

The mounting frame 3 is rotatively hinged at the lower frame 2. The lower end of the support rod 5 is rotatively hinged at the lower frame 2. The upper end of the support rod 5 is fixed at the mounting frame 3 with a plurality of fixing pins 4a, 4b, 4c, 4d of the first fixing means that enable the mounting frame 3 to rotate downward toward the lower frame 2.

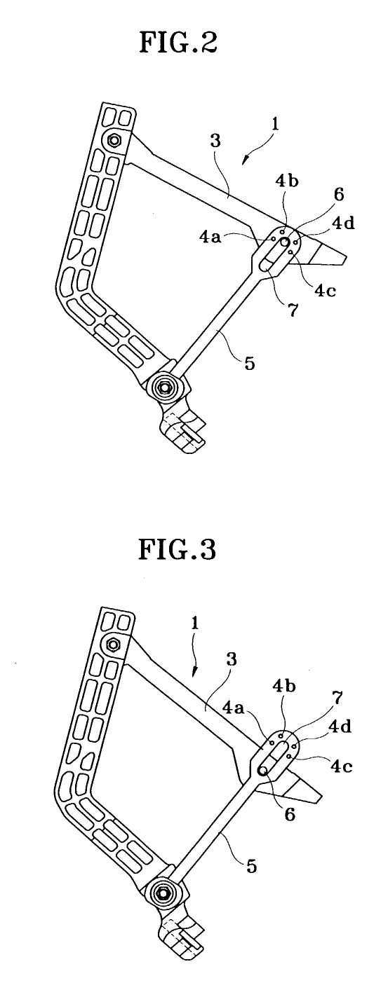

Preferably, the material employed for the fixing pins 4a-4d provides a fixing strength and an angle between the support rod 5 and the mounting frame 3 to stably support the shift lever assembly during normal use. However, the mounting frame 3, fastened with the support rod 5 rotates following destruction of the fixing pins 4a-4d during an impact such as a vehicle collision (FIGS. 2 and 3). The fixing strength of fixing pins 4a-4d can be readily determined and varies in accordance with the type of vehicle model. It is preferred that the fixing pins 4a-4d are constructed from a plastic material. In alternative embodiments the fixing pins 4a-4d are constructed from a metal, an alloy, or a ceramic material that is configured to shear upon the application of force during a vehicle accident.

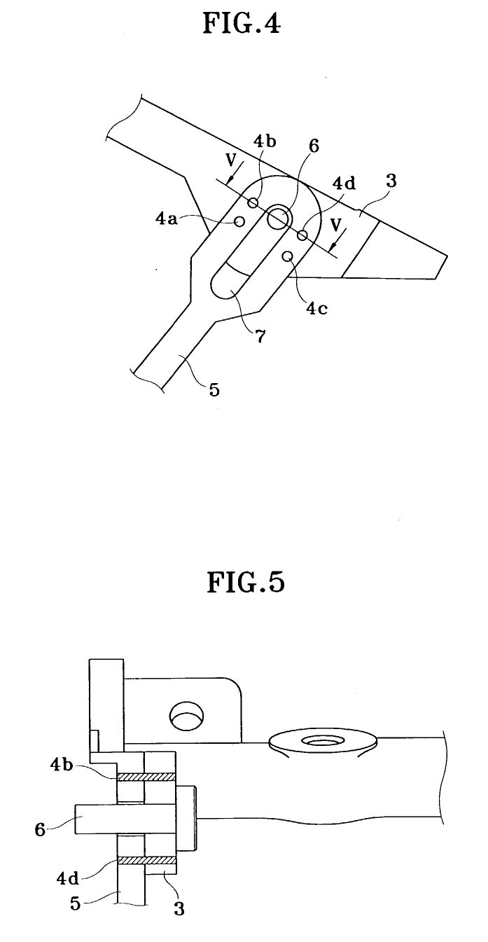

A second fixing means is installed in the support rod 5 and the mounting frame 3. The second fixing means includes a guide hole 7 that is vertically formed at the upper end of the support rod 5. Also included is a guide pin 6 that protrudes from the mounting frame 3 for insertion into the guide hole 7. Therefore, the upper end of the support rod 5 is fixed by the fixing pins 4a-4d to the mounting frame 3. Furthermore, the protruding guide pin 6 is inserted into the guide hole 7 of the support rod 5 (FIGS. 4 and 5).

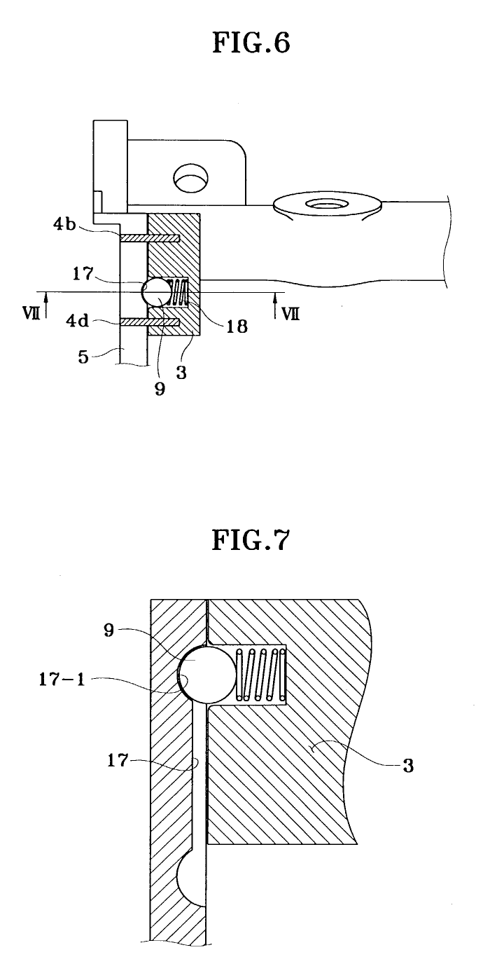

According to FIGS. 6 and 7, another embodiment of the second fixing means includes a guide groove 17 formed in the support rod 5 at a side facing the mounting bracket 3. Also included is a concave part 17-1 of the guide groove 17 that receives a ball 9. The ball 9 is supported elastically toward the concave part 17-1 by an elastic spring 18 installed at the mounting bracket 3.

Hereinafter, the operations and effects of the present invention will be described.

In use, a shift lever assembly (not shown) is mounted over the mounting frame 3 of the mounting bracket 1. The mounting frame 3 supports the shift lever assembly stably against a certain level of impact. However, during a vehicle collision, if part of the occupant's body contacts the shift lever assembly with sufficient impact, the mounting bracket 1 releases its support state and absorbs part of the impact, thereby, minimizing injury to the occupant. Impact on the shift lever assembly releases the support state of the mounting bracket 1 by displacing the fixing pins 4a-4d and causing the mounting frame 3 to rotate toward the lower frame 2. The guide pin 6 protruding from the mounting frame 3 moves along the guide hole 7 and contacts the bottom of the guide hole 7. Thereby, absorbing, buffering, and displacing some of the impact energy of an occupant's body.

According to another preferred embodiment, the hitching unit includes a ball 9 elastically and forcibly supported at the concave part 17-1 by an elastic spring 18 (FIGS. 6 and 7). The mounting bracket 3 and the support rod 5 are typically fixed and maintained by the fastening force that occurs when the ball 9 is hitched to the upper concave part 17-1 of the guide groove 17 by the force of the elastic spring 18. Further, the fastening force of the fixing pins 4a-4d maintains the mounting frame 3 in position with the support rod 5. During a collision, when a force greater than a threshold quantity impacts the mounting bracket 3, the fixing pins 4a-4d are destroyed or shear. Mounting frame 3 thereafter rotates downward. Accordingly, the ball 9 moves out of the concave part 17-1 compressing the elastic spring 18. The ball 9 then moves downward along the guide groove 17, with the elastic spring 18 compressed, and guides the rotation of the mounting bracket 3. Therefore, the rotation of the mounting bracket 3 absorbs part of the impact force transferred by an occupant to the shifting apparatus during a collision.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A fascia-mounted shift lever bracket, comprising:
a mounting frame rotatively coupled on one side to a lower frame; and
a support rod rotatably coupled between the lower frame and said mounting frame opposite to said coupling of said mounting frame with the lower frame;
a first fixing means connecting said support rod and said mounting frame such that said first fixing means will be destroyed upon application of a load to said mounting frame; and
a second fixing means that will be fixed after rotation of said mounting frame when said first fixing means is destroyed.

2. The bracket as defined in claim 1, wherein said first fixing means is formed with plastic pins for fixing said mounting frame and said support rod.

3. The bracket as defined in claim 1, wherein said second fixing means comprises:
a guide pin fixed at said mounting frame; and
wherein said support rod defines a guide hole vertically formed therein for receiving said guide pin.

4. The bracket as defined in claim 1, wherein said second fixing means comprises:
a guide groove vertically configured within said support rod;
a concave part configured within said guide groove;
a ball configured and dimensioned to be inserted into said guide groove and said concave part; and
an elastic spring installed at said mounting bracket for elastically supporting said ball toward said guide groove and said concave part.

5. A fascia-mounted shift lever bracket comprising:
a mounting frame having one side rotatively coupled to a lower frame; and
a support rod that connects and supports the lower frame and the other side of said mounting frame wherein said support rod and said mounting frame are connected by a fixing means that will be destroyed when more than a certain level of load is applied to said mounting frame.

6. The bracket as defined in claim 5, wherein said fixing means is formed with plastic pins.

7. The bracket as defined in claim 6, wherein said fixing means is constructed with a plurality of plastic pins.

8. A fascia-mounted bracket, comprising:
a lower frame coupled with a vehicle body;
a mounting frame rotatably coupled with said lower frame:
a support rod rotatably coupled on a first end with said lower frame; and
a breakaway fixation coupling a second end of said support rod with said mounting frame.

9. The bracket of claim 8, wherein said breakaway fixation comprises:
at least one fixation pin coupling said mounting frame with the second end of said support rod; and
a protrusion pin protruding from said mounting frame;
wherein said second end of said support rod defines a groove configured and dimensioned to receive said protrusion pin and wherein said protrusion pin travels along said groove following breakaway of said fixation pin.

10. The bracket of claim 9, wherein said fixation pin comprises a plurality of fixation pins.

11. The bracket of claim 10, wherein said fixing pins are selected from the group consisting of metal pins, plastic pins, alloy pins, and ceramic pins.

12. The bracket of claim 8, wherein said breakaway fixation comprises:
at least one fixation pin coupling said mounting frame with the second end of said support rod wherein said mounting frame defines a receptacle and the second end of said support rod defines a guide groove and concave part; and
a ball elastically supported by an elastic member disposed within said receptacle wherein said ball is received by said guide groove and said concave part.

13. The bracket of claim 12, wherein said guide groove further comprises a plurality of concave parts.

14. The bracket of claim 12, wherein said fixation pin is a metal pin, a plastic pin, an alloy pin, or a ceramic pin.
